(19) United States
(12) Patent Application Publication
(10) Pub. No.: US 2020/0327566 A1
(43) Pub. Date: Oct. 15, 2020

(54) SYSTEMS AND METHODS FOR EVALUATING AND PREDICTING FUEL STATION USAGE

(71) Applicant: Ford Global Technologies, LLC, Dearborn, MI (US)

(72) Inventors: Jae Hyung Lim, Canton, MI (US); James Isaac, Ypsilanti, MI (US); Jeremy Lerner, Oak Park, MI (US); Jason Woo, Northville, MI (US)

(73) Assignee: Ford Global Technologies, LLC, Dearborn, MI (US)

(21) Appl. No.: 16/384,536

(22) Filed: Apr. 15, 2019

(51) Int. Cl. G06Q 30/02; H04W 4/021; H04W 4/35

(52) U.S. Cl. CPC G06Q 30/0205; H04W 4/35; H04W 4/021; G06Q 30/0202

(57) ABSTRACT

Systems and methods evaluating and predicting fuel station usage are provided herein. An example method includes establishing geo-fencing parameters around one or more fueling stations; determining when vehicles encounter geo-fences of the fueling stations based on the geo-fencing parameters, such that encounters relative to the geo-fences are associated with entry timestamps; determining an aggregate number of the vehicles encountering each of the geo-fences over a period of time based on the entry timestamps; determining waiting times for the vehicles at each of the fueling stations; and transmitting a message to a portion of the vehicles that indicate which of the fueling stations are busy or have short wait times based on the aggregate number of the vehicles encountering each of the geo-fences and the waiting times.

### TECHNICAL FIELD

The present disclosure relates to systems and methods that evaluate and predict fuel station usage, and in which some embodiments implement geo-fencing and image processing of fuel station related data in support thereof.

### BACKGROUND

Customers often obtain fuel at the same gas station regularly because of a seemingly optimal location or a rewards program that happened to catch their interest. Furthermore, fuel prices can vary dramatically between fueling stations, even when these fueling stations are in close proximity to one another.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a flowchart of an example method for providing predictive fueling station features as disclosed herein, and which implement geo-fencing.

FIG. 3 is a flowchart of another example method of the present disclosure that includes image processing.

FIG. 4 is a flowchart of a method for determining low fuel conditions.

FIG. 5 is a flowchart of an example method using geo-fencing along with a plurality of parameters to predictive fueling station features.

FIG. 6 is a flowchart of a method that can be performed in accordance with the present disclosure

### DETAILED DESCRIPTION

### Overview

The disclosure is directed to, among other things, identifying and monetizing fueling trends at a predefined map of gas stations. In certain embodiments, connected vehicle data is obtained and sold to gas stations to allow the gas stations to model their behaviors to attract more customers. Information may include the number of vehicles that pass by a gas station and fill up at another gas station, the average wait time at the gas station, and trends in terms of usage during certain hours (which may allow gas stations to offer incentives during off-peak times, for example). Gas stations may also be able to integrate advertisements into the gas station recommendations. More so, vehicles may be able to use their cameras to capture historical gas price data when they fill up at a particular gas station. This summary is not intended to limit any aspect of the disclosure. That is, other aspects of the disclosure are disclosed herein.

In some embodiments, the systems and methods disclosed herein can be configured to utilize geo-fencing, vehicle tracking, image processing, and other features to determine real-time data regarding fuel stations. In some embodiments, these systems and methods provide predictive features for forecasting fuel prices using real-time data. These real-time data can include, but are not limited to, fuel station to vehicle proximity, real-time price comparisons, fuel price based on image processing of pricing signs, and so forth. These real-time data may be obtained from a plurality of connected vehicles in some embodiments. Various messages and reporting can be enabled through the use of real-time data.

Advantageously, these systems and methods enable a vehicle/user to make more intelligent and data driven decisions based on crowdsourced vehicle data collected automatically from connected vehicles such that a user's experience can be improved and even highly customized. In some embodiments, the systems and methods disclosed herein can determine the popularity of specific fueling stations based on GPS coordinates and timestamps and suggest popular fueling stations (could be determined with aggregate counts over time) within a particular geo-fence as well as the ideal time to fill up in order to minimize wait time. As used herein, fueling station may refer to a gas or the like fueling station or an electric vehicle charging station.

In one embodiment, based on a predefined map of proximate fueling stations, the systems and methods disclosed herein can identify fueling trends and allow customers and/or fueling station operators to leverage the same for their respective benefit. For example, these systems and methods could identify connected vehicles with a low fuel level condition that pass or are about to pass a particular brand of fueling stations without stopping, but which subsequently fill up at another brand's fueling station. These systems and methods also enable fueling station brands to determine when price incentive programs are giving them a competitive advantage.

In another embodiment, the systems and method disclosed herein can calculate vehicle fueling wait time, which may include a time frame extending between when a user enters a fueling station until the vehicle fuel level rises to an approximately full level. Trends in the approximate wait time can be identified and the systems and methods can suggest a time and day for short wait time at a pump of a fueling station. These data can also be used by fueling stations to adopt additional incentives during off-peak hours (especially if many vehicles are passing a given fueling station and filling up at a nearby competitor). Further, users can specify their preferred gas station experiences so that the systems and methods can optimize suggestions within their preferences. For example, if a user only fills up at fueling stations attached to grocery stores or big box stores, the systems and methods may filter out standalone fueling stations.

In yet another embodiment, the systems and methods can utilize real-time data to determine how long a vehicle stays at a fueling station before a fill up so as to infer whether or not a driver made a purchase inside an attached convenience store/fueling station. Fueling station brands can utilize these data to more effectively advertise their incentive programs based on customer usage patterns. The systems and methods can also integrate advertisements as part of a suggested fill up time and location, providing maximum value to the customer, giving them the shortest wait time, lowest price, nearest station, and best incentive program, just to name a few.

Furthermore, when the systems and methods may detect that a connected vehicle has completed a fueling/charging event or enters a geo-fence of a fueling station, the systems and methods can automatically capture (or cause a camera of a vehicle to capture) an image of a fuel price sign. Using data from a plurality of vehicles, the systems and methods can create a high-fidelity fueling station price history database. These and other advantages of the present disclosure are provided in greater detail herein.

### Illustrative Embodiments

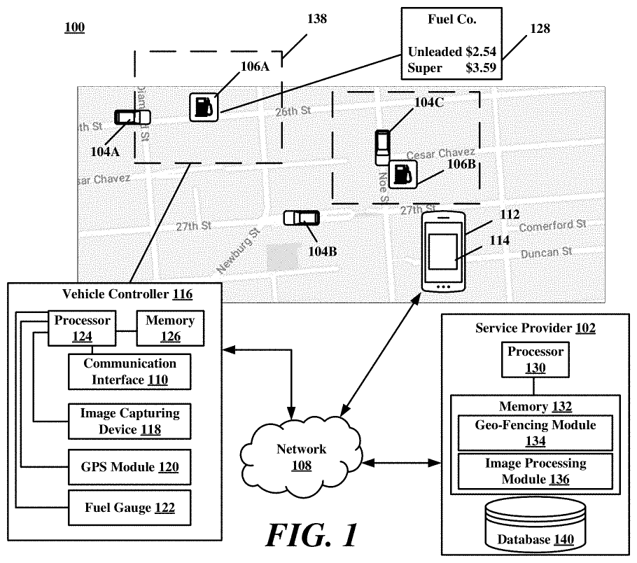

Turning now to the drawings, FIG. 1 depicts an illustrative architecture 100 in which techniques and structures of the present disclosure may be implemented. The illustrative architecture 100 may include a service provider 102, a plurality of vehicles such as vehicle 104A, 104B, and 104C, a plurality of fueling stations such as fueling station 106A and 106B and a network 108. The network 108 may include any one or a combination of multiple different types of networks, such as cable networks, the Internet, wireless networks, and other private and/or public networks. In some instances, the network 108 may include cellular, Wi-Fi, or Wi-Fi direct. In some embodiments, some functionalities disclosed herein can be executed entirely at the vehicle level. In other embodiments, some functionalities disclosed herein can be executed entirely at the service provider level. In other embodiments, some functionalities disclosed herein can be executed cooperatively at the vehicle level and the service provider level together.

In various embodiments, each of the vehicles 104A and 104B are configured similarly and are generally referred to as connected vehicles. Contrastingly, the vehicle 104C is a legacy or non-connected vehicle. For brevity, the vehicle 104A will be discussed in greater detail. In general, connectivity of a vehicle includes, for example, the vehicle 104A comprising a means for communicatively coupling with resources (such as the service provider 102) over the network 108. This can be facilitated in some embodiments using a communications interface(s) 110 that allows the vehicle 104A to communicate with the service provider 102 using any one or more of the aforementioned communication protocols. Alternatively, for vehicle 104C (or a user thereof), a user can utilize a connected device, such as a smartphone or mobile device 112. That is, the functionalities that are available at the vehicle level may also be enabled using a mobile device 112 that executes an application 114. Thus, the functionalities which will be described in detail herein which are attributable to the vehicle 104A (and specifically the vehicle controller discussed below) can also be executed by a mobile device to allow non-connected vehicles and their users to participate in using the systems and methods disclosed herein.

In general, the vehicle 104A comprises a vehicle controller 116, the communications interface 110, an image capturing device 118, a GPS module 120, and a fuel gauge 122. In some embodiments, the vehicle controller 116 comprises a processor 124 and memory 126. The processor 124 executes instructions stored in the memory 126 to provide various functionalities which are described in greater detail herein. To be sure, references to various functions provided by the vehicle controller 116 implicitly include the processor 124 executing instructions in memory 126.

The image capturing device 118 can include any suitable image capturing device such as a camera. The GPS module 120 tracks a location of the vehicle 104A in real or near-real-time. Other suitable methods for determining the location of the vehicle 104A can also be utilized in place of, or in addition to, GPS.

With regard to the fueling stations 106A and 106B, each can be configured similarly to one another. In some embodiments, each of the fueling stations can include a fuel price sign, also referred to as a fuel price indicator 128. Each of the fueling stations can provide various types of fuel, each having a different fuel type and/or price, which are reflected on the fuel price indicator 128. These prices may vary over time as dictated by the operator of the fueling station. In some embodiments, the prices of fuel can be selectively modified using feedback provided in accordance with the present disclosure. Also, the fueling station operators (through use of the service provider 102 in some embodiments) can provide incentives or offers to vehicle operators based on feedback provided in accordance with the present disclosure. In general, each of the fueling stations can establish and maintain an account on the service provider 102 which allows the service provider 102 to provide messages to the vehicles in accordance with the present disclosure. Likewise, each vehicle can be associated with a record, account, or in some instances a unique identifier that allows data (such as vehicle encounters with geo-fences) collected from the vehicles to be linked to a particular vehicle.

According to some embodiments, the service provider 102 can comprise a processor 130 and memory 132. The processor 130 executes instructions stored in the memory 132 to provide various functionalities which are described in greater detail herein. To be sure, references to various functions provided by the service provider 102 implicitly include the processor 130 executing instructions in memory 132. In general, the memory stores modules such as a geo-fencing module 134 and an image processing module 136.

In some embodiments, the service provider 102 can establish geo-fences around one or more of the fueling stations, such as a geo-fence 138 around the fueling station 106A. In general, each of the fueling stations is associated with a specific geolocation. The size and shape of the geo-fence 138 are defined by geo-fencing parameters which can vary according to desired implementation parameters. In some embodiments, the geo-fencing module 134 can be configured to generate and maintain the geo-fence 138 and detect when vehicles, such as vehicle 104A enter a geo-fence. The geo-fencing module 134 can determine that the vehicle 104A has entered the geo-fence 138 around the fueling station 106A when a signal provided by the GPS module 120 of the vehicle 104A is matched by the geo-fencing module 134 to a location of the vehicle 104A is within the geo-fence 138. In general, the geo-fencing module 134 can determine when vehicles encounter a geo-fence. Encountering a geo-fence can include entering, exiting, or being within a predefined distance to the geo-fence.

In other embodiments, the geo-fencing module 134 can detect when vehicles are about to enter or exit a geo-fence based on location changes of a vehicle over time. The geo-fencing module 134 can detect when a vehicle has entered and/or left a geo-fence without stopping at an associated fueling station. The geo-fencing module 134 can detect when a vehicle enters and leaves a fueling station with a particular fuel tank level based on signals received from the vehicle controller 116. That is, the vehicle controller 116 can be configured to determine a fuel level of the fuel gauge 122 and transmit an indication of the fuel level to the service provider 102. In sum, the geo-fencing module 134 can detect the relative position of various vehicles to fueling stations, as well as the time spent at each fueling station (based on geo-fence data), as well as vehicle fuel levels. In some instances, the geo-fencing module 134 can track and time stamp any data collected from either the fueling stations or vehicles to enable the creation of a high-fidelity fueling station price history database (database 140). The varied types of data that can be stored in this database 140 are disclosed in greater detail herein.

In accordance with the present disclosure, the service provider 102 can also utilize the image processing module 136 to obtain fuel price data from images of fuel price indicators gathered by the vehicles. In some embodiments, when the geo-fencing module 134 determines that the vehicle 104A is within the geo-fence 138, the service provider 102 can instruct the vehicle controller 116 to activate the image capturing device 118 and obtain images of the fuel price indicator 128. In an alternative embodiment, the service provider 102 can instruct the user to obtain pictures of the fuel price indicator 128 using their mobile device 112. According to some embodiments, the vehicle controller 116 can also be configured to process images of fuel price indicators gathered by a vehicle, rather than (or in addition to) relying on image processing at the service provider 102 level. Thus, the functionalities disclosed with respect to the image processing module 136 can be integrated into the vehicle controller 116.

Once received, the image processing module 136 can process the image(s) to determine fuel prices for each of the fuel types. In this example, a fuel type of Unleaded has a price of $2.54 per gallon, whereas a fuel type of Super has a price of $3.59 per gallon, as reflected in the fuel price indicator 128. The image processing module 136 can implement any type of textual analysis such as optical character recognition to determine the fuel types and/or prices. Once obtained, these fuel types and price data can be linked to a geolocation of an associated fueling station, along with a time stamp. These data can be stored in the database 140, along with similar data obtained by other vehicles over time and across a geographical area. This allows the service provider 102 to build and maintain a robust historical and real-time data set that allows for the provision of various services to either or both of the vehicles and/or the fueling stations, as will be discussed infra with respect to specific use cases. In some embodiments, these data can allow for real-time and dynamic responses by the vehicles and/or the fueling station. For example, if the fuel price indicator 128 is digital, the service provider 102 can provide the fueling station with competitive pricing based on image processing of fuel prices. The fueling station can automatically update the fuel price indicator 128 to match or beat a lowest fuel price as determined from the database 140. In some embodiments the fuel price indicator 128 is a manual indicator that can be changed by an individual.

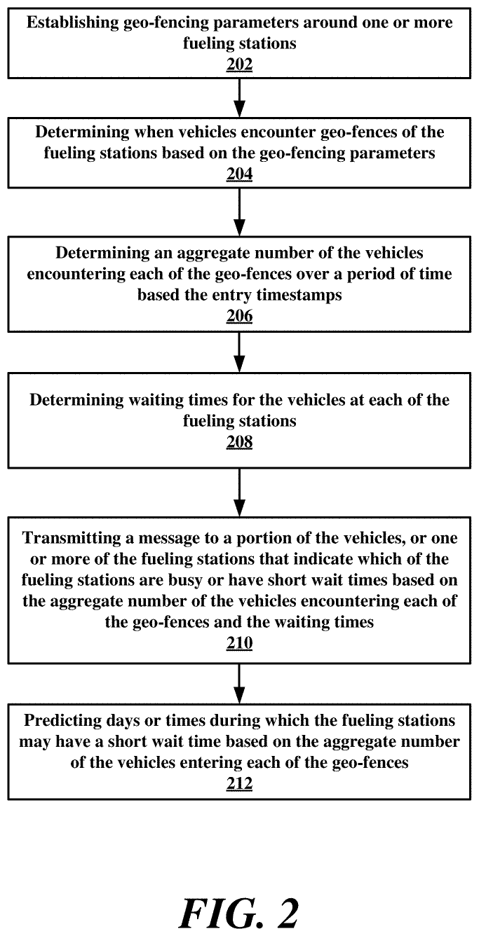

FIG. 2 is a flowchart of an example method of the present disclosure. The method includes a step 202 of establishing geo-fencing parameters around one or more fueling stations. For example, each fueling station is associated with its own geo-fence having a size and shape that are selected according to design parameters.

Next, the method includes a step 204 of determining when vehicles encounter geo-fences of the fueling stations based on the geo-fencing parameters. This process involves detecting consonance between a location of a vehicle and a geo-fence of a fueling station. In some embodiments, encountering a geo-fence can include detecting proximity of a vehicle to a geo-fence of a fueling station, entry of the vehicle into the geo-fence of a fueling station, and/or exit of a vehicle from inside a geo-fence of a fueling station. As noted above, these entries, exits, or proximity indications, or other similar encounters relative to the geo-fences are associated with entry timestamps. This allows the service provider to log events according to time.

In some embodiments, the method can include a step 206 of determining an aggregate number of the vehicles encountering each of the geo-fences over a period of time, based on the entry timestamps. In some embodiments, the method includes a step 208 of determining waiting times for the vehicles at each of the fueling stations. In one embodiment, a waiting time can be calculated by detecting when vehicles enter a geo-fence for a fueling station and then detecting when the vehicles exit the geo-fence. An average wait time can be calculated over data for a plurality of vehicles refueling at a particular fueling station at or about the same point in time.

In various embodiments, the method includes a step 210 of transmitting a message to a portion of the vehicles, or one or more of the fueling stations that indicate which of the fueling stations are busy or have short wait times based on the aggregate number of the vehicles encountering each of the geo-fences and the waiting times.

In one example, a waiting time can be calculated as a time frame extending between when a vehicle enters one of the geo-fences until a fuel level of the vehicle is approximately full. As noted above, the service provider can receive indications of fuel level for a vehicle (e.g., fuel gauge measurements) and use the same to determine if the vehicle obtained fuel at a particular fueling station or not.

As a historical set of data are obtained and stored in the database of the service provider, the method can also include a step 212 of predicting days or times during which the fueling stations may have a short wait time based on the aggregate number of the vehicles entering each of the geo-fences. Using historical data, the service provider can infer or predict days or times where fueling wait times will be high or low based on historical data. In addition to using aggregate numbers, the method can also use average wait time calculations.

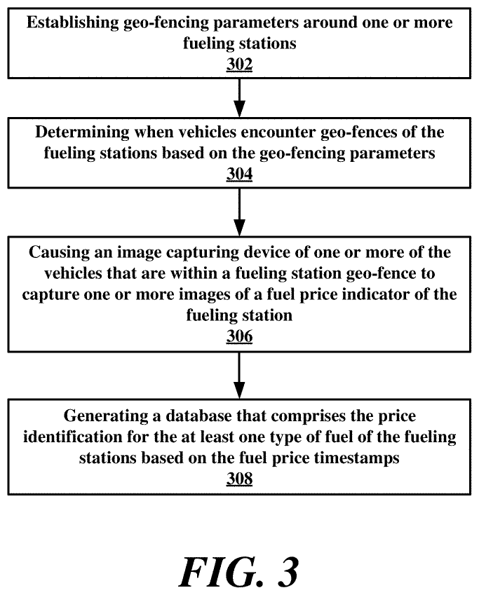

FIG. 3 is a flowchart of another example method of the present disclosure. The method includes a step 302 of establishing geo-fencing parameters around one or more fueling stations. For example, each fueling station is provided with its own geo-fence having a size and shape that are selected according to design parameters.

Next, the method includes a step 304 of determining when vehicles encounter geo-fences of the fueling stations based on the geo-fencing parameters. This process involves detecting consonance between a location of a vehicle and a geo-fence of a fueling station. In some embodiments, encountering a geo-fence can include detecting proximity of a vehicle to a geo-fence of a fueling station, entry of the vehicle into the geo-fence of a fueling station, and/or exit of a vehicle from inside a geo-fence of a fueling station. As noted above, these entries, exits, or proximity indications, or other similar encounters relative to the geo-fences are associated with entry timestamps. This allows the service provider to log events according to time.

Next, the method includes a step 306 of causing an image capturing device of one or more of the vehicles, which are within a fueling station geo-fence, to capture one or more images of a fuel price indicator of the fueling station. To be sure, the fuel price indicator can include a sign or other indication of a price for at least one type of fuel. Again, these data are time stamped and can be stored in a database. The method can include a step 308 of generating a database that comprises the price identification for the at least one type of fuel of the fueling stations based on the fuel price timestamps. These data can be stored along with the data regarding the vehicle encounters with the fueling station geo-fences.

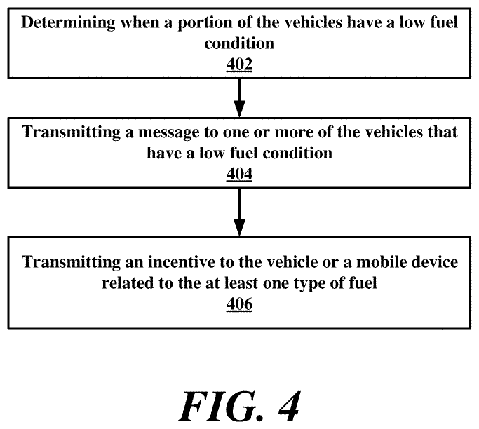

FIG. 4 is a flowchart of an example method related to detecting low fuel conditions in a vehicle and transmitting messages to the vehicle in response. The method of FIG. 4 can be used with any of the methods herein disclosed. In some embodiments, the method comprises a step 402 of determining when a portion of the vehicles have a low fuel condition. This process can be effectuated by the vehicle controller determining a fuel level based on fuel gauge readings. Fuel levels are determined relative to a fuel capacity for the vehicle in some instances. The vehicle controller can transmit this low fuel condition to the service provider in some instances. This step can occur as the vehicle is driven by a user. The service provider can determine one or more fueling stations which are proximate the vehicle (near a GPS location of the vehicle). In response, the method includes a step 404 of transmitting a message to one or more of the vehicles that have a low fuel condition. The message can be generated and transmitted by the service provider. In some embodiments, the message comprises an identification of the fueling stations and the price identification for the at least one type of fuel. The available fueling stations and price data can be provided in a list or on an example map as illustrated in FIG. 1.

As noted above, the service provider system can be configured to maintain a profile for each of the fueling stations, which enable the service provider system to transmit relevant incentives or offers to vehicles upon certain conditions. In general, the method includes a step 406 of transmitting an incentive to the vehicle or a mobile device related to the at least one type of fuel. The incentive or offer could include a discount code for a fuel discount or other similar offering provided by the fueling station.

That is, fueling stations can identify incentives or offers that can be delivered to the vehicles upon certain conditions. In some embodiments, a condition could include the low fuel condition. In another example, a condition could include the vehicle being within a predetermined distance from a fueling station. In yet another example, a condition could include the vehicle being within a predetermined distance from a preferred brand of fueling station. In one example, a condition could include a price adjustment of a fuel price. These are merely examples and are not intended to be limiting. Another non-limiting example is provided with respect to time of day. In one embodiment, if fueling stations have few customers between 12 pm and 1 pm, the fueling station could offer additional incentives to fill up during that time, such as a lower price. Further, it is advantageous to a driver to receive a notification that the price is lower and there will be a short wait time after a lunch outing, for example. This will enable the driver to take advantage of the offer, even if they would not have known about the incentive otherwise. The systems and methods of the present disclosure provide the driver with these types of actionable data.

In some embodiments, the method can further include receiving a preference profile for a user. In various embodiments, the preference profile comprising fueling station preferences of the user. The method further includes applying a filter that removes at least a portion of the fueling stations indicated in the message that do not comply with the fueling station preferences of the user. For example, if a user has a preferred brand or type of fueling station, the preference profile may identify these brands and suggest these branded fueling stations in lieu of other options. In some embodiments, the filter can be conditional so as to allow a non-preferred brand if the vehicle is in a low fuel condition or if a substantial change in price is identified. Again, each of these types of determinations can be made in real-time using real-time data gathered from the vehicles and/or the fueling stations.

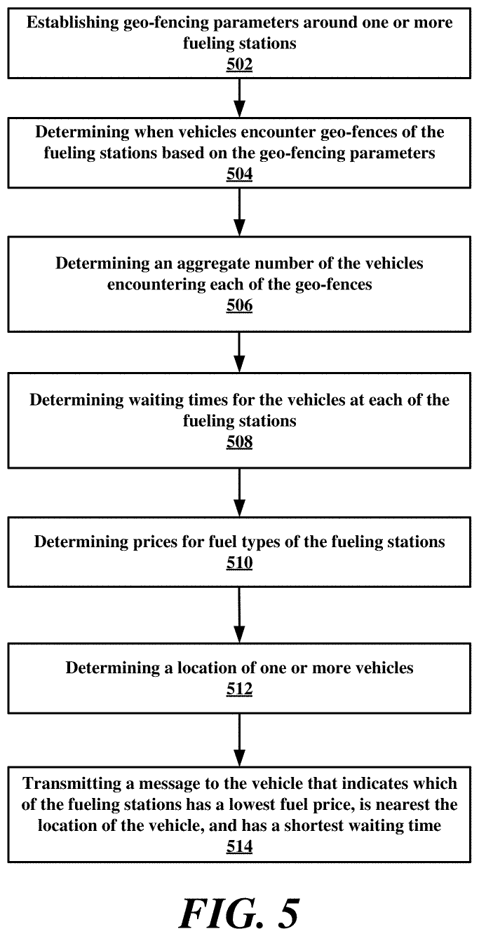

FIG. 5 is a flowchart of another method of the present disclosure that includes determining a plurality of parameters and transmitting messages to vehicles in accordance with the parameters. The method includes a step 502 of establishing geo-fencing parameters around one or more fueling stations. For example, each fueling station is provided with its own geo-fence having a size and shape that are selected according to design parameters.

Next, the method includes a step 504 of determining when vehicles encounter geo-fences of the fueling stations based on the geo-fencing parameters. This process involves detecting consonance between a location of a vehicle and a geo-fence of a fueling station. In some embodiments, encountering a geo-fence can include detecting proximity of a vehicle to a geo-fence of a fueling station, entry of the vehicle into the geo-fence of a fueling station, and/or exit of a vehicle from inside a geo-fence of a fueling station. As noted above, these entries, exits, or proximity indications, or other similar encounters relative to the geo-fences are associated with entry timestamps. This allows the service provider to log events according to time.

Next, the method includes a step 506 of determining an aggregate number of the vehicles encountering each of the geo-fences. These data allow the service provider to infer whether a fueling station is busy or available. In addition, the method can include a step 508 of determining waiting times for the vehicles at each of the fueling stations. Example methods for calculating wait times from geo-fence entrances and exits can be used. Next, the method includes a step 510 of determining prices for fuel types of the fueling stations and a step 512 of determining a location of one or more vehicles. Collectively, these data can be used to create a message that indicates which of the fueling stations has a lowest fuel price, is nearest the location of the vehicle, and/or has a shortest waiting time. Based on steps 502-512, the method can include a step 514 of transmitting a message to the vehicle that indicates which of the fueling stations has a lowest fuel price, is nearest the location of the vehicle, and/or has a shortest waiting time.

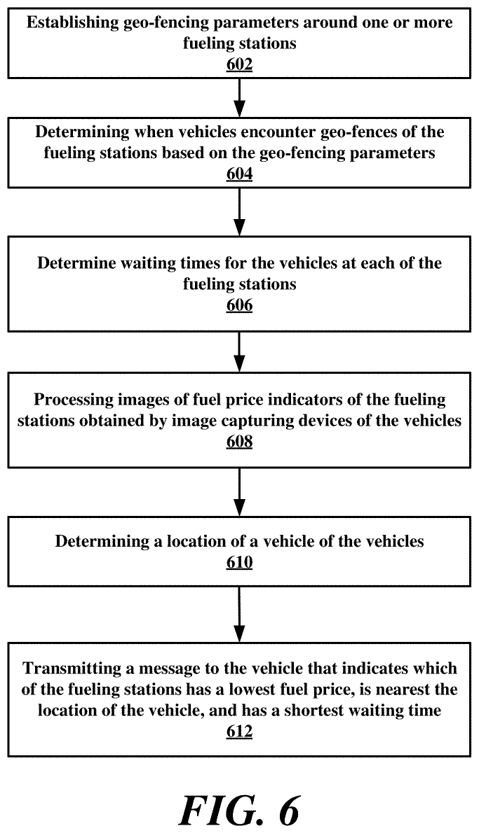

As noted above, price identifications can be obtained from images of fuel price indicators of the fueling stations obtained by image capturing devices of at least a portion of the vehicles. FIG. 6 is a flowchart of another example method that can be executed, for example, by the service provider of FIG. 1. The method includes a step 602 of establishing geo-fencing parameters around one or more fueling stations. For example, each fueling station is provided with its own geo-fence having a size and shape that are selected according to design parameters.

Next, the method includes a step 604 of determining when vehicles encounter geo-fences of the fueling stations based on the geo-fencing parameters. This process involves detecting consonance between a location of a vehicle and a geo-fence of a fueling station. In some embodiments, encountering a geo-fence can include detecting proximity of a vehicle to a geo-fence of a fueling station, entry of the vehicle into the geo-fence of a fueling station, and/or exit of a vehicle from inside a geo-fence of a fueling station. As noted above, these entries, exits, or proximity indications, or other similar encounters relative to the geo-fences are associated with entry timestamps. This allows the service provider to log events according to time. Also, in some embodiments, an inferential link can be established between a changed fuel level for vehicles and the existence of a fueling station. That is, even if a geo-fence for a fueling station has not been established, the fact that many vehicles have a change in fuel level within a particular area implies that a fueling station exists (perhaps a new station was built but not yet included in the service provider's database). Additionally, the change in fuel level of one or more vehicles is a reliable indicator to begin capturing images to attempt to capture the fuel price indicator. If a vehicle is in the fueling station geo-fence but the fuel level does not change, it is possible that the GPS coordinates are in error or that there are multiple other businesses near the fueling station. In either case, it is less likely that images captured automatically would contain the fuel price indicator.

The method further includes a step 606 of determine waiting times for the vehicles at each of the fueling stations, as well as a step 608 of processing images of fuel price indicators of the fueling stations obtained by image capturing devices of the vehicles. Again, the fuel price indicators comprise a price for at least one fuel type. Next, the method includes a step 610 of determining a location of a vehicle of the vehicles. Using the collective data provided in steps 602-610, the method includes a step 612 of transmitting a message the vehicle that indicates which of the fueling stations has a lowest fuel price, is nearest the location of the vehicle, and has a shortest waiting time.

In one example use case, based on a predefined map of fueling stations, the systems and methods disclosed herein can identify fueling trends and monetize them. For example, a number of connected vehicles with low fuel levels that pass particular brands of fueling stations without stopping, but subsequently fill up at another brand's fueling station is valuable information that can be sold to partnering fueling stations. That is, fueling stations can utilize the systems and methods disclosed herein to determine when price incentive programs are giving them a competitive advantage.

On a related note, the systems and methods herein can calculate wait time, counting from when a user enters a gas station until the fuel level rises. The systems and methods can then search for trends in the approximate wait time and suggest a time and day for short wait time at the pump. The systems and methods disclosed herein, and fueling stations, can use collected data to offer additional incentives during off-peak hours (especially if many cars are passing the station and filling up at a nearby competitor). Further, users can specify their preferred gas station experiences so systems and methods disclosed herein can optimize within their preferences.

In another example, the systems and methods disclosed herein can track how long a vehicle stays at a fueling station before the fill up is started and after it is completed. Therefore, estimations can be made as to whether or not a driver made a purchase inside the attached convenience store and sell that data to fueling station brands.

Additionally, the systems and methods allow fueling station brands to more effectively advertise their incentive programs based on customer usage patterns, and unobtrusively integrate these advertisements as part of a suggested fill up time and location, providing maximum value to the customer, giving them the shortest wait time, lowest price, nearest station, and best incentive program.

Furthermore, when the systems and methods can detect that a connected vehicle has completed a fueling/charging event or even enters a gas station geo-fence, and in response, automatically capture an image of the prices in order to build a fueling station price history database. Note that even if not every vehicle is able to accurately capture the fuel prices within its camera range, data from the large number of connected vehicles will ensure a high fidelity database.

### Example Embodiments

In some instances, the following examples may be implemented together or separately by the systems and methods described herein.

Example 1 may include a method, comprising: establishing geo-fencing parameters around one or more fueling stations; determining when vehicles encounter geo-fences of the fueling stations based on the geo-fencing parameters, wherein encounters relative to the geo-fences are associated with entry timestamps; determining an aggregate number of the vehicles encountering each of the geo-fences over a period of time based on the entry timestamps; determining waiting times for the vehicles at each of the fueling stations; and transmitting a message to a portion of the vehicles that indicate which of the fueling stations are busy or have short wait times based on the aggregate number of the vehicles encountering each of the geo-fences and the waiting times.

Example 2 may include the method according to example 1, further comprising predicting days or times during which the fueling stations may have a short wait time based on the aggregate number of the vehicles encountering each of the geo-fences.

Example 3 may include the method according to example 2 and/or some other example herein, wherein the waiting time comprises a time frame extending between when a vehicle of the vehicles enters one of the geo-fences until a fuel level of the vehicle is approximately full.

Example 4 may include the method according to example 1 and/or some other example herein, wherein based on entering the geo-fence, the method further comprises causing an image capturing device of at least a portion of the vehicles to capture one or more images of a fuel price indicator of the fueling stations, the fuel price indicator comprising a price for at least one type of fuel, the images being associated with fuel price timestamps.

Example 5 may include the method according to example 4 and/or some other example herein, further comprising generating a database that comprises the price for the at least one type of fuel of the fueling stations based on the fuel price timestamps.

Example 6 may include the method according to example 5 and/or some other example herein, further comprising: determining when a portion of the vehicles have a low fuel condition; and transmitting a message to the portion of the vehicles that have a low fuel condition, the message comprising an identification of the fueling stations and the price for the at least one type of fuel.

Example 7 may include the method according to example 6 and/or some other example herein, further comprising transmitting an incentive to the vehicle or a mobile device related to the at least one type of fuel.

Example 8 may include the method according to example 1 and/or some other example herein, further comprising: receiving a preference profile for a user, the preference profile comprising fueling station preferences of the user; and applying a filter that removes at least a portion of the fueling stations indicated in the message that do not comply with the fueling station preferences of the user.

Example 9 may include the method according to example 1 and/or some other example herein, further comprising determining an event time frame that extends between when a vehicle enters a geo-fence, completes fueling, and the vehicle exits the geo-fence.

Example 10 may include a method, comprising: establishing geo-fencing parameters around one or more fueling stations; determining when vehicles encounter geo-fences of the fueling stations based on the geo-fencing parameters; determining an aggregate number of the vehicles encountering each of the geo-fences; determining waiting times for the vehicles at each of the fueling stations; determining prices for fuel types of the fueling stations; determining a location of a vehicle of the vehicles; based on the location of the vehicle, transmitting a message to the vehicle that indicates which of the fueling stations has a lowest fuel price, is nearest the location of the vehicle, and has a shortest waiting time.

Example 11 may include the method according to example 10, wherein the prices are obtained from images of fuel price indicators of the fueling stations obtained by image capturing devices of at least a portion of the vehicles, the fuel price indicators comprising the prices.

Example 12 may include the method according to example 11 and/or some other example herein, further comprising: determining when a portion of the vehicles have a low fuel condition; and transmitting a message to the portion of the vehicles that have a low fuel condition, the message comprising an identification of the fueling stations and the prices for the fuel types of the fueling stations.

Example 13 may include the method according to example 12 and/or some other example herein, further comprising transmitting an incentive to the vehicle or a mobile device related to the fuel types.

Example 14 may include a system, comprising: a processor; and a memory for storing instructions, the processor executing the instructions stored in the memory to: establish geo-fencing parameters around one or more fueling stations; determine when vehicles encounter geo-fences of the fueling stations based on the geo-fencing parameters; determine an aggregate number of the vehicles encountering each of the geo-fences; determine waiting times for the vehicles at each of the fueling stations; process images of fuel price indicators of the fueling stations obtained by image capturing devices of at least a portion of the vehicles, the fuel price indicators comprising a price for at least one fuel type; determine a location of a vehicle of the vehicles; based on the location of the vehicle, transmit a message to the vehicle that indicates which of the fueling stations has a lowest fuel price, is nearest the location of the vehicle, and has a shortest waiting time.

Example 15 may include the system according to example 14, wherein the processor further executes the instructions to: determine when a portion of the vehicles have a low fuel condition; and transmit a message to the portion of the vehicles that have a low fuel condition, the message comprising an identification of the fueling stations and the price for the fuel types.

Example 16 may include the system according to example 15 and/or some other example herein, wherein the processor further executes the instructions to generate and transmit an incentive to the vehicle or a mobile device related to the fuel types.

Example 17 may include the system according to example 16 and/or some other example herein, wherein the processor further executes the instructions to: receive a preference profile for a user, the preference profile comprising fueling station preferences of the user; and apply a filter that removes at least a portion of the fueling stations indicated in the message that do not comply with the fueling station preferences of the user.

Example 18 may include the system according to example 17 and/or some other example herein, wherein the processor further executes the instructions to cause the image capturing devices of at least a portion of the vehicles to capture one or more images of a fuel price indicator of the fueling stations, the fuel price indicator comprising a price identification for at least one type of fuel, the images being associated with fuel price timestamps.

Example 19 may include the system according to example 18 and/or some other example herein, wherein the processor further executes the instructions to predict days or times during which the fueling stations may have a short wait time based on the aggregate number of the vehicles encountering each of the geo-fences.

Example 20 may include the system according to example 19 and/or some other example herein, wherein the processor further executes the instructions to determine the waiting time based on a time frame extending between when a vehicle of the vehicles enters one of the geo-fences until a fuel level of the vehicle is approximately full.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method, comprising:
establishing geo-fencing parameters around one or more fueling stations;
determining when vehicles encounter geo-fences of the fueling stations based on the geo-fencing parameters, wherein encounters relative to the geo-fences are associated with entry timestamps;
determining an aggregate number of the vehicles encountering each of the geo-fences over a period of time based on the entry timestamps;
determining waiting times for the vehicles at each of the fueling stations; and
determining a message to at least one of the vehicles that indicates which of the fueling stations are busy or have short wait times based on the aggregate number of the vehicles encountering each of the geo-fences and the waiting times.

2. The method according to claim 1, further comprising predicting times during which the fueling stations comprise a short wait time based on the aggregate number of the vehicles encountering each of the geo-fences.

3. The method according to claim 2, wherein the waiting time comprises a time frame extending between when at least one vehicle of the vehicles enters one of the geo-fences until a fuel level of the at least one vehicle is approximately full.

4. The method according to claim 1, wherein based on entering the geo-fence, the method further comprises causing an image capturing device of at least one of the vehicles to capture one or more images of a fuel price indicator of the fueling stations, the fuel price indicator comprising a price for at least one type of fuel, the images being associated with fuel price timestamps.

5. The method according to claim 4, further comprising generating a database that comprises the price for the at least one type of fuel based on the fuel price timestamps.

6. The method according to claim 5, further comprising:
determining when at least one vehicle of the vehicles have a low fuel condition;
and
transmitting a message to the at least one vehicle of the vehicles that has a low fuel condition, the message comprising an identification of the fueling stations and the price for the at least one type of fuel.

7. The method according to claim 6, further comprising transmitting an incentive to the at least one vehicle or a mobile device related to the at least one type of fuel.

8. The method according to claim 1, further comprising:
receiving a preference profile for a user, the preference profile comprising fueling station preferences of the user; and
applying a filter that removes at least a portion of the fueling stations indicated in the message that do not comply with the fueling station preferences of the user.

9. The method according to claim 1, further comprising determining an event time frame that extends between when at least one vehicle of the vehicle enters a geo-fence, completes fueling, and the at least one vehicle exits the geo-fence.

10. A method, comprising:
establishing geo-fencing parameters around one or more fueling stations;
determining when vehicles encounter geo-fences of the fueling stations based on the geo-fencing parameters;
determining an aggregate number of the vehicles encountering each of the geo-fences;
determining waiting times for the vehicles at each of the fueling stations;
determining prices for fuel types of the fueling stations;
determining a location of at least one vehicle of the vehicles;
based on the location of the at least one vehicle, transmitting a message to the at least one vehicle that indicates which of the fueling stations has a lowest fuel price, is nearest the location of the at least one vehicle, and has a shortest waiting time.

11. The method according to claim 10, wherein the prices are obtained from images of fuel price indicators of the fueling stations obtained by image capturing devices of the vehicles, the fuel price indicators comprising the prices.

12. The method according to claim 11, further comprising:
determining when at least one vehicle of the vehicles has a low fuel condition;
and
transmitting a message to the at least one vehicle that has a low fuel condition, the message comprising an identification of the fueling stations and the prices for the fuel types of the fueling stations.

13. The method according to claim 12, further comprising transmitting an incentive to the at least one vehicle or a mobile device related to the fuel types.

14. A system, comprising:
a processor; and
a memory for storing instructions, the processor executing the instructions stored in the memory to:
establish geo-fencing parameters around one or more fueling stations;
determine when vehicles encounter geo-fences of the fueling stations based on the geo-fencing parameters;
determine an aggregate number of the vehicles encountering each of the geo-fences;
determine waiting times for the vehicles at each of the fueling stations;
process images of fuel price indicators of the fueling stations obtained by image capturing devices of the vehicles, the fuel price indicators comprising a price for at least one fuel type;
determine a location of at least one vehicle of the vehicles;
based on the location of the at least one vehicle, transmit a message to the at least one vehicle that indicates which of the fueling stations has a lowest fuel price, is nearest the location of the at least one vehicle, and has a shortest waiting time.

15. The system according to claim 14, wherein the processor further executes the instructions to:
determine when a portion of the vehicles have a low fuel condition; and
transmit a message to the portion of the vehicles that have a low fuel condition, the message comprising an identification of the fueling stations and the price for the fuel types.

16. The system according to claim 15, wherein the processor further executes the instructions to generate and transmit an incentive to the portion of the vehicles or a mobile device related to the fuel types.

17. The system according to claim 16, wherein the processor further executes the instructions to:
receive a preference profile for a user, the preference profile comprising fueling station preferences of the user; and
apply a filter that removes at least a portion of the fueling stations indicated in the message that do not comply with the fueling station preferences of the user.

18. The system according to claim 17, wherein the processor further executes the instructions to cause the image capturing devices the vehicles to capture one or more images of a fuel price indicator of the fueling stations, the fuel price indicator comprising a price identification for at least one type of fuel, the images being associated with fuel price timestamps.

19. The system according to claim 18, wherein the processor further executes the instructions to predict one or more times during which the fueling stations comprises a short wait time based on the aggregate number of the vehicles encountering each of the geo-fences.

20. The system according to claim 19, wherein the processor further executes the instructions to determine the waiting time based on a time frame extending between when the at least one vehicle of the vehicles enters one of the geo-fences until a fuel level of the at least one vehicle is approximately full.
